(19) United States
(12) Patent Application Publication
(10) Pub. No.: US 2023/0005224 A1
(43) Pub. Date: Jan. 5, 2023

(54) PRESENTING REAL WORLD VIEW DURING VIRTUAL REALITY PRESENTATION

(71) Applicant: Lenovo (Singapore) Pte. Ltd., Singapore (SG)

(72) Inventors: Gary D. Cudak, Wake Forest, NC (US); Nathan J. Peterson, Oxford, NC (US); John Michael Petersen, Wake Forest, NC (US)

(21) Appl. No.: 17/365,680

(22) Filed: Jul. 1, 2021

(51) Int. Cl. G06T 19/00; G06K 9/00; G10L 25/51; G10L 15/22

(52) U.S. Cl. CPC G06T 19/006; G06K 9/00288; G10L 25/51; G10L 15/22; G06T 2210/62; G10L 2015/223

(57) ABSTRACT

In one aspect, a device includes a processor, a display accessible to the processor, and storage accessible to the processor. The storage includes instructions executable by the processor to present first virtual reality (VR) content on the display. The instructions are also executable to determine that an end user-defined trigger has occurred for transitioning from presenting VR content to presenting the real-world environment. Responsive to the determination, the instructions are executable to transition presentation of at least part of the first VR content to presentation of the real-world environment.

### FIELD

The disclosure below relates to technically inventive, non-routine solutions that are necessarily rooted in computer technology and that produce concrete technical improvements. In particular, the disclosure below relates to techniques for presenting a real-world view during a virtual reality presentation.

### BACKGROUND

As recognized herein, virtual reality (VR) content is highly immersive and can cause a user to become psychologically detached from their current real-world environment, sometimes to their detriment. As also recognized herein, existing VR devices lack the technical capability to adequately provide an immersive VR experience while still keeping the user adequately aware of certain real-world surroundings. Thus, there are currently no adequate solutions to the foregoing computer-related, technological problem.

### SUMMARY

Accordingly, in one aspect a device includes at least one processor, a display accessible to the at least one processor, and storage accessible to the at least one processor. The storage includes instructions executable by the at least one processor to present first virtual reality (VR) content on the display. The instructions are also executable to determine that an end user-defined trigger has occurred for transitioning from presenting VR content to presenting augmented reality (AR) content. Responsive to the determination, the instructions are executable to transition presentation of at least part of the first VR content to presentation of first AR content.

Thus, in some examples the instructions may be executable to, responsive to the determination, transition presentation of part but not all of the first VR content to presentation of the first AR content so that at least some opaque VR content continues to be presented on the display while the first AR content is also presented on the display. In other examples, the instructions may be executable to transition to concurrently presenting the first AR content and no VR content responsive to the determination. Additionally, the first AR content may indicate virtual objects from the first VR content that would otherwise be shown in VR absent the end user-defined trigger occurring.

Still further, in some example implementations the instructions may be executable to transition back to presentation of VR content and no AR content responsive to the end user-defined trigger no longer existing.

As for the end user-defined trigger, in some examples it may include another person besides an end user entering a discrete area in which the device is disposed. For example, the trigger may include a particular person besides the end user entering the discrete area and so the instructions may be executable to transition to presentation of the first AR content based on the particular person entering the discrete area but not based on other people entering the discrete area. The particular person may have been designated by the end user as being the end user-defined trigger and the other people may not have been designated by the end user as being the end user-defined trigger. In various examples, the particular person may be recognized using facial recognition and an image indicated by the end user.

Additionally, or alternatively, the end user-defined trigger may include recognition of an end user-designated sound such as human speech. The end user-designated sound may have also been uploaded by the end user. Another end user-defined trigger may include recognition of any sound above a threshold sound level.

In another aspect, a method includes presenting first virtual reality (VR) content on a display. The method also includes determining that an end user-defined criterion exists for transitioning VR content from opaque to at least partially transparent. Responsive to the determining, the method includes transitioning at least part of the first VR content from opaque to at least partially transparent.

In various examples, the end user-defined criterion may include a change in ambient lighting, a particular weather event occurring, a particular time of day being reached, and/or recognition of an end user-designated song.

In still another aspect, at least one computer readable storage medium (CRSM) that is not a transitory signal includes instructions executable by at least one processor to present first virtual content on a display. The instructions are also executable to determine that an end user-defined criterion exists for transitioning from opaque presentation of virtual content to presentation of a real-world environment. Responsive to the determination, the instructions are executable to present, via the display, the real-world environment in place of at least some of the first virtual content.

In some examples, the first virtual content may include a virtual object and an outline of the virtual object may be presented over top of the real-world environment as presented via the display.

Additionally, in some examples the first virtual content may be presented at a first device and the end user-defined criterion may include an incoming communication being received at a second device different from the first device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a block diagram of an example AR/VR headset consistent with present principles;

FIGS. 4 and 5 show virtual content being presented on a display of a headset in different presentation modes consistent with present principles;

FIG. 6 illustrates example logic in example flow chart format that may be executed by a headset or other device consistent with present principles;

FIG. 7 shows an example graphical user interface (GUI) that may be presented on a display for an end user to select various triggers or criteria to use for triggering a partial or full AR content presentation mode; and

FIG. 8 shows an example GUI that may be presented for an end user to record a particular sound or voice to use as a trigger or criterion for a partial or full AR content presentation mode.

### DETAILED DESCRIPTION

Among other things, the detailed description below describes systems and methods to select among or define various ambient and other conditions that may cause a switch between presenting virtual reality (VR) content and AR-only content (or AR content with partial VR content). An end user may define or select among ambient triggers to alter the VR operation mode.

For example, the device may be pre-programmed with specific sounds (e.g., doorbells, a door opening, human speech, a dog barking) and/or specific visual/physical objects (e.g., a particular human or dog) to recognize as triggers. Additionally, or alternatively, the sounds or visual objects may be user-assigned where, for example, the user may indicate sound snippets or imagery of specific objects or people for the device to use. For example, the end user may configure AR to be triggered responsive to the device identifying the user's wife but not the user's child or identifying the user's dog but not the user's cat.

Once the triggers have been configured by the end-user, the headset or other device being used may observe its ambient environment using its sensors (like a camera and microphone) and watch for the user-defined triggers as occurring. Then upon detecting a trigger as occurring, the device may take an end user-defined action that may be the same for all triggers or unique to the particular trigger that is detected (as either way specified by the end-user). For example, the action may be entering a partial AR state where most of the virtual world is still opaquely rendered and visible to the user except for at a small portion of the display through which the trigger object is located, which can shift to AR for that portion for the user to see the trigger object. However, the end user-defined action might instead be for the device to go fully AR in that all virtual objects and other virtual content are presented transparent or semi-transparently in AR (with no opaque rendering of objects). In either case, the AR presentation mode may continue until user intervention commands the device to return to a full VR state (e.g., a voice command) or the trigger object or other condition leaves or ceases to occur.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C # or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

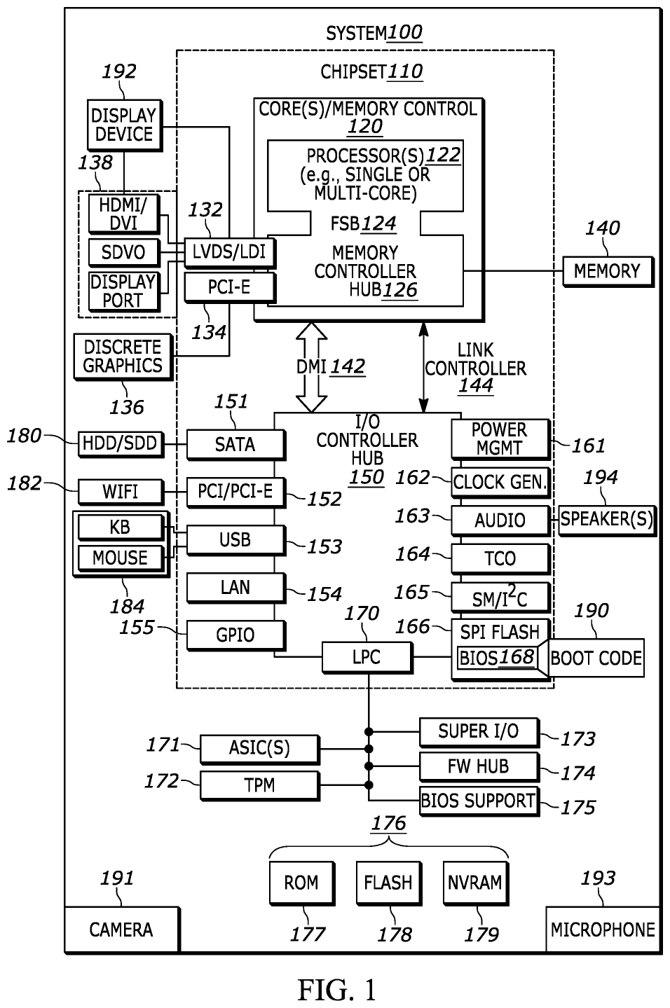

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include one or more cameras 191 that gather one or more images and provide the images and related input to the processor 122. The camera(s) 191 may include thermal imaging cameras, infrared (IR) cameras, digital cameras such as webcams, three-dimensional (3D) cameras, and/or other camera types otherwise integrated into the system 100 and controllable by the processor 122 to gather still images and/or video consistent with present principles. The system 100 may include further an audio receiver/microphone 193 that provides input from the microphone 193 to the processor 122 based on audio that is detected, such as via a user providing audible input/commands to the microphone consistent with present principles.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

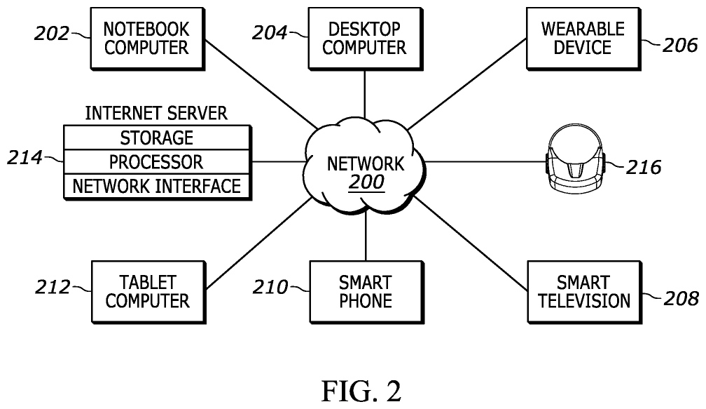

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a headset 216, and a server 214 such as an Internet server that may provide cloud storage accessible to the devices 202-212, 216. It is to be understood that the devices 202-216 are configured to communicate with each other over the network 200 to undertake present principles.

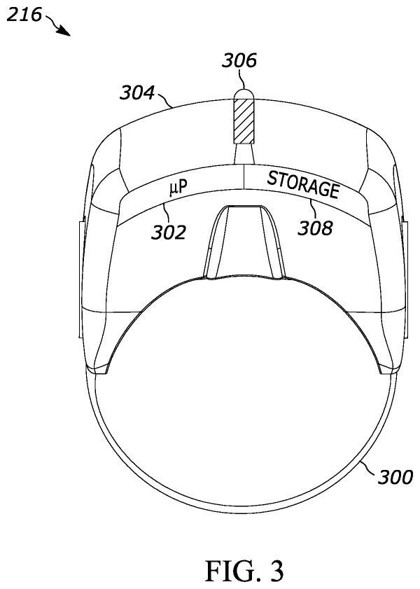

Referring now to FIG. 3, it shows a top plan view of an example virtual reality/augmented reality headset, such as the headset 216, consistent with present principles. The headset 216 may include a housing 300, at least one processor 302 in the housing 300, and a transparent AR display or non-transparent VR display 304 accessible to the at least one processor 302 and coupled to the housing 300. The display 304 may for example have discrete left and right eye pieces as shown for presentation of stereoscopic 3D VR images/objects and/or 3D AR images/objects consistent with present principles as well as for presenting other types of graphical objects.

The headset 216 may also include one or more forward-facing cameras 306. As shown, the camera 306 may be mounted on a bridge portion of the display 304 so that it may have an outward-facing field of view similar to that of an end user wearing the headset 216. However, note that additional cameras may also be located at other headset locations as well and may be oriented outwards away from the headset 216 to have different fields of view in different directions relative to the headset 216 for identifying various triggers consistent with present principles. Also note that cameras on other devices in communication with the headset might also be used for identifying triggers.

Furthermore, note that the forward-facing camera(s) 306 and other cameras may be used for, among other things, object recognition, computer vision, image registration, spatial mapping, simultaneous localization and mapping (SLAM), etc. for AR/VR headset tracking and content rendering consistent with present principles. Further note that in some examples, inward-facing cameras may also be mounted within the headset 216 and oriented to image the user's eyes for eye tracking.

Additionally, note that the headset 316 may also include storage 308 accessible to the processor 302 and coupled to the housing 300, as well as still other components not shown for simplicity such as a network interface for communicating over a network such as the Internet and a battery for powering components of the headset 216 such as the camera(s) 306.

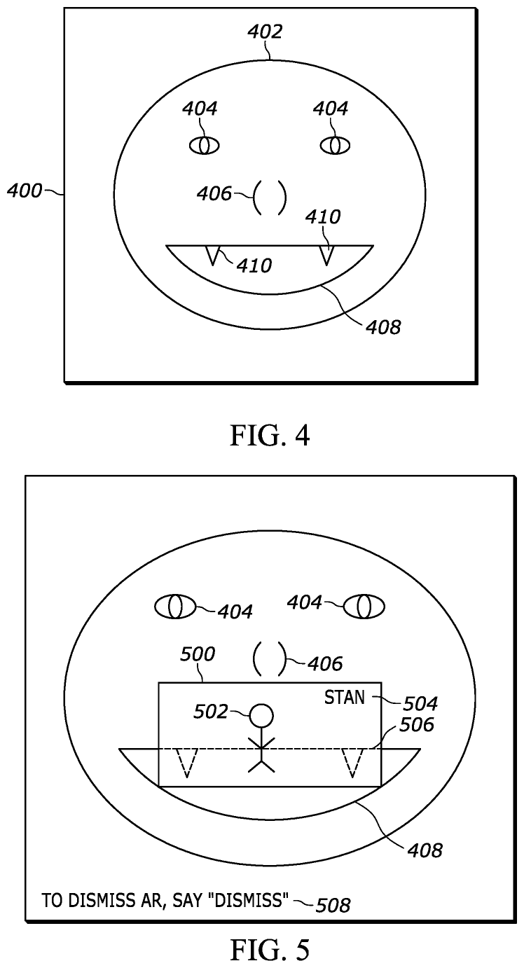

Before moving on to FIG. 4, note again that the headset 216 may be an AR headset with a transparent display. The headset 216 may also be a VR headset that may not have a transparent display but that may still be able to present virtual AR objects/content on its display concurrently with a real-world, real-time camera feed of an environment imaged by one of the headset's cameras to still provide an AR experience to the user. Consistent with present principles, this AR technique might similarly apply to other AR-capable mobile devices that have non-transparent displays where those devices might have rear-facing cameras for providing a real-world live feed as part of an AR presentation presented on the device's display. Those devices might include smartphones and tablet computers, for example. Also note that computerized smart glasses may also be used in lieu of the headset 216 to implement present principles.

Now in reference to FIG. 4, VR content 400 is shown as presented on a display of a headset consistent with present principles. The VR content might be part of a video game, a motion picture or video, a VR demo, or another type of VR presentation. In the current example, the VR content includes a virtual object such as a 3D-rendered vampire 402. As may also be appreciated from FIG. 4, the vampire 402 has its own virtual objects in the form of two eyes 404, a nose 406, and a mouth 408 with pointed teeth 410.

Now suppose the headset or another local device in communication with the headset identifies an end user-defined trigger as occurring. In this example, assume the trigger is detecting the voice and/or face of a particular person 502 other than the end-user. Responsive to detecting the voice and/or face, FIG. 5 shows that the headset may present a view window 500 showing the person 502 in the real-world environment around the headset. The window 500 might also include a text overlay 504 indicating the name of the identified person 502.

Note here that if the display of the headset on which the VR content 400 is presented is a transparent display that may go fully-opaque for VR content presentation (e.g., and thus not allow discernable images/external light from the external environment to pass through), then upon detection of the trigger the portion of the display corresponding to the window 500 may be made transparent by controlling the display's passthrough mechanism(s) so that the user can see the real world environment via the display by looking through the transparent window 500 into the actual real world environment. The display that is used may be, for example a MicroLED display, a liquid crystal on silicon display, or a transparent OLED display.

Also note that in some examples, the real-world location of the particular person 502 relative to the headset may be tracked on the display using computer vision so that as the headset moves and/or the person 502 changes position with respect to the headset, the transparent window 500 may float about the display across various display locations and over top of different areas of the VR content 400 to continue indicating the person 502 through the window 500 in the actual viewing direction of the person 502. The actual viewing direction itself from the display to the person 502 may be relative to the center forward-facing axis of the display. However, further note that in other examples the transparent window 500 may remain at a fixed place on the display, such as in the center for the end user to see directly in front of them or fixed at a lower left-hand corner to be less intrusive.

Note even further that in addition to or in lieu of making part or all of the display transparent for the end-user to look through the display into the real-world environment, the headset's display may also present a camera feed of the real-world environment from one or more of the headset's cameras for the AR presentation mode. The camera feed may be presented in the window 500, or if a full-screen AR mode is to be used in response to the trigger then the camera feed may be presented full-screen on the display. Either way, this might be done in embodiments where the display is not a transparent display (or even in embodiments where the display is transparent). However, even here the headset may still use computer vision and one or more of its cameras to track the real-world location of the person 502 with respect to the headset and present the window 500 (with camera feed) via the display in the actual viewing direction of the person 502 similar to the description above. Though in certain other examples, the window 500 with the camera feed may be presented at a fixed place on the display also as set forth above.

But regardless of whether the window 500 is see-through or presents a camera feed of the real-world environment, further note that in some examples no VR-related content or other computer-generated graphical objects may be presented within the window 500 while the real-world environment is shown via the window 500. In other examples, some VR content may be presented in the window 500 as converted into AR content. The converted AR content may indicate one or more virtual objects from the VR content 400 that would otherwise be shown in VR at the same respective display locations and times as the corresponding AR images as part of a full-screen VR presentation had the end user-defined trigger not occurred.

So, for example, a graphics processing unit (GPU), central processing unit (CPU), or other processor on the headset or accompanying device may be used to perform image segmentation and feature detection techniques such as edge detection and ridge detection to identify the outlines, contours, and other features of various virtual objects forming part of the VR content 400 in real time (e.g., as the VR content is loaded for presentation) to convert the VR content into AR content. However, the outlines, contours, and other features of VR objects for AR rendering might also be preestablished in the VR program data itself as programmed by the developer of the VR presentation.

Regardless, as may be appreciated from FIG. 5, in this example the headset's display presents an AR outline 506 of the upper portion of the mouth 408 as well as fanged teeth 410 of the vampire 402 as superimposed over top of the real-world view in the window 500 so the end user may continue to immerse themselves in the virtual world of the VR presentation while still viewing the person 502 in the real world via the headset display. In certain examples and though not shown for clarity, particular contours of the mouth and teeth from the VR version of the vampire might also be superimposed on the window 500 (e.g., in addition to the outline 506). The outlines and/or contours may be presented monochrome in a single color or may be presented in plural respective colors that correspond to the actual VR colors of the respective portions of the virtual object itself as would be shown in VR. And in certain specific examples, an even fuller AR presentation may be effected within the window 500 for an even greater virtual world/real world blending, where grayscale object shading for the teeth 410 and upper portion of the mouth 408 may be used to indicate additional portions of the object 402 or other virtual content 400 that would otherwise be obstructed by the window 500. Using these techniques, the view/feed of the real world can still be seen though the outline and other AR renderings of the virtual object while other portions of the virtual object are rendered transparently or semi-transparently in the window 500.

Still in reference to FIG. 5, further note that the headset may present text instructions 508 on the display. As shown, the instructions 508 may indicate that the user may dismiss the AR window 500 and go back to full screen VR for the content 400 by saying the word “dismiss”. Then once the headset detects the word “dismiss” based on input from its microphone and execution of speech recognition, the headset may cease presenting the view of the real world via the display and again return to full screen VR presentation similar to as discussed above in reference to FIG. 4.

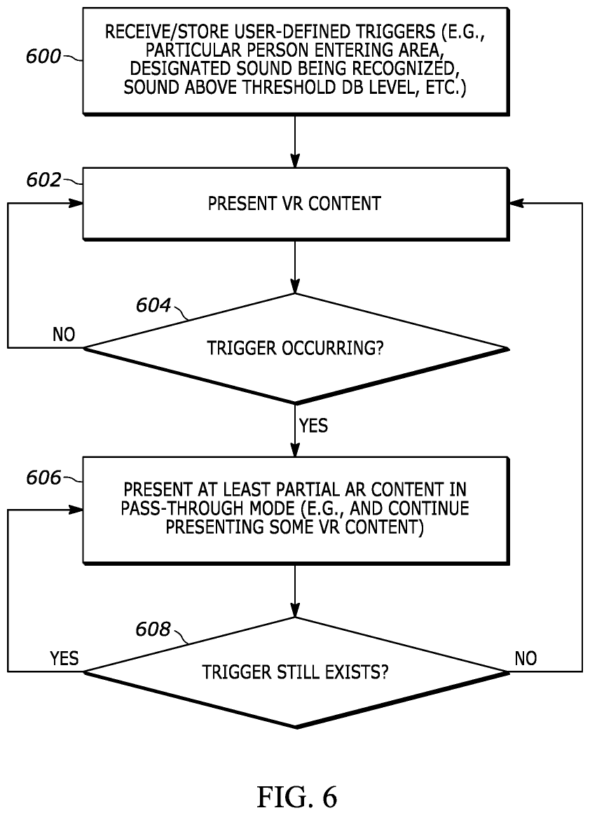

Continuing the detailed description in reference to FIG. 6, it shows example logic that may be executed by a device such as the system 100, headset 300, or other device consistent with present principles. Note that while the logic of FIG. 6 is shown in flow chart format, state logic or other suitable logic may also be used.

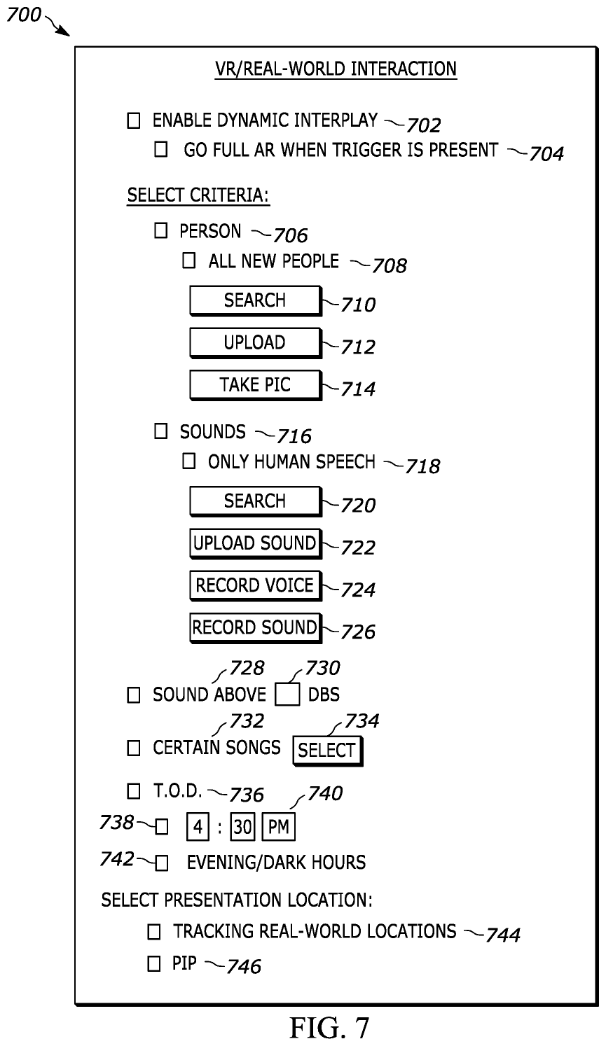

Beginning at block 600, the device may receive and store end user-defined triggers for transitioning from full screen VR presentation to an at least partial passthrough mode where the real world can be seen through at least part of the VR content, which may become AR content as described herein. The triggers themselves may be defined using a graphical user interface (GUI) such as the GUI 700 of FIG. 7, which will be described shortly. But for now, assume as examples that the end user has defined triggers to be one or more of a particular person designated by the end-user as entering a discrete area around the headset, a designated sound being recognized, and/or any sound within the headset's environment being above a threshold number of decibels as detected at a microphone on the headset. Note that the discrete area itself may be defined by a user-designated height, length, and width for the area as provided via input boxes on a GUI like the GUI 700.

From block 600 the logic may proceed to block 602. At block 602 the device may begin presenting VR content full-screen on the device's display. Thereafter the logic may proceed to decision diamond 604 where the device may determine whether one or more of the user-designated triggers are currently occurring. For example, the particular person designated by the user may have entered the room in which the user and device are disposed (as recognized using a camera), or an end user-designated doorbell sound may be identified (as recognized using a microphone).

Thus, responsive to a negative determination the logic may revert back to block 602 and proceed again from there, but an affirmative determination may instead cause the logic to proceed to block 606. At block 606 the device may present AR content (e.g., virtual object outlines, contours, and/or partial grayscale object shading) on at least part of the display in a passthrough mode so that the end-user can also acclimate to their surroundings. The AR content may be presented full screen with no fully opaque VR objects being presented so that the user may be provided with the greatest possible view of their surroundings, or the AR content may only be presented in a window like the window 500 described above so that matching opaque VR content may still be presented on surrounding portions of the display. From block 606 the logic may then proceed to decision diamond 608.

At diamond 608 the device may determine whether one or more of the end user-defined triggers still currently exist within the device's environment. An affirmative determination may cause the logic to revert back to block 606 where AR content and real-world view continue to be presented, whereas a negative determination may cause the logic to revert back to block 602 where full screen opaque VR content may again be presented.

Additionally, or alternatively, note that at diamond 608 the device may also determine whether a voice command or other command has been received to go back to full screen VR presentation. Based on determining that such a command has been received, the logic may revert back to block 602, whereas responsive to no such command being received the logic may revert back to block 606.

Now describing FIG. 7, it shows an example graphical user interface (GUI) 700 that may be presented on the display of a device configured to undertake present principles, such as the display of the headset 300. The GUI 700 may be reached by navigating a settings menu of the device or may be presented responsive to a user command to begin a particular VR presentation, for example.

As shown in FIG. 7, the GUI 700 may include various options that may be selectable by an end-user to customize interplay between VR immersion and real-world awareness as described herein. In the example below, each option or sub-option may be selected by directing touch or cursor or other suitable input to the check box adjacent to the respective option.

The GUI 700 may include a first option 702 that may be selectable to set or enable the device to in the future present AR content along with a real-world view upon detection of one or more end user-defined triggers or criteria consistent with present principles. For example, selection of the option 702 may set or configure the device to execute the functions described above in reference to FIGS. 4 and 5 as well as to execute the logic of FIG. 6. Additionally, if desired the option 702 may be accompanied by a sub-option 704 that may be selectable to set or configure the device to present a real-world view and AR content full-screen while a user-defined trigger is identified as currently occurring (rather than only presenting a real-world view window with AR content along with matching opaque VR content at surrounding portions).

The GUI 700 may also list various options that the end-user may designate as triggers or criteria for entering the passthrough mode with AR content being presented in part or all of the display screen. For example, an option 706 may be selectable to set or enable the device to use detection of people generally as one of the criteria. Sub-option 708 may then be selected to set or configure the device to switch to a partial or full AR mode when any person is detected as entering the device's environment (or a discrete end user-defined area) during a VR presentation so that the identified person is shown to the end user in the AR mode via a camera feed or making part of the display transparent.

However, a search button/selector 710 may also be selected to launch an Internet browser or other application to navigate to a stored Internet image of a face of a particular person that the end-user wants to designate as a person whose entrance into the environment/discrete area triggers the AR mode (e.g., as may be stored on a social networking site accessed through a social networking application). Additionally, or alternatively, the end user may select the button 712 to launch a file browser through which the end user may select and upload a local or remotely-stored image of the person's face. The end user might also select the button 714 to launch a camera application at the device, where a real time camera feed of the device's camera may be presented for the end user to then take and automatically upload a photograph of the desired person's face.

But regardless of which button 710-714 is selected, the corresponding image of the person's face that is ultimately selected may then be used as a reference image for facial recognition to determine whether the trigger has occurred (the person entering the area in this case, with non-designated people entering not being a trigger). For example, the device may, during presentation of VR content, execute facial recognition using real time camera feeds from different headset cameras facing different directions to identify the person as entering the area.

As also shown in FIG. 7, the GUI 700 may include an option 716 that may be selectable to set or enable the device to use detection of discrete sounds as a criterion for triggering a real-world window view or full AR rendering view. In this case, the view of the real world may either show a forward-facing field of view from the device regardless of the location of the source of sound, or the view/camera feed may instead show the specific person or other object that the device has identified as producing the discrete sound(s).

Sub-option 718 may then be selected to set or configure the device to only use detection of human speech as a trigger/criterion to switch to a partial or full AR mode when any human speech is detected in the device's environment during a VR presentation (rather than using any detected sound as the trigger). Then, also for the AR mode, in some examples the device may use action recognition to identify a particular person in one or more of the device's camera feeds as speaking the words detected by the device's microphone to determine that person as the one to show to the end user via the display in the AR mode (e.g., the window 500 described above). In other examples, the entire display may render AR content along with showing the real world, or the real-world window that is used may show a field of view straight ahead of the device regardless of sound source location.

The GUI 700 also shows that a search button 720 may be selected to launch an Internet browser or other application to navigate to a sound file for a sound such as a doorbell or door closing that the end-user wants to designate as a sound whose detection triggers the AR mode. Additionally, or alternatively, the end user may select the button 722 to launch a file browser through which the end user may select and upload a local or remotely-stored sound file of the sound.

Also, for using sound as a trigger/criterion, the end user might select the button 724 to launch a voice/sound recording application at the device. The application may then be used to record a voice sample provided by a person that is then used as a template for subsequently executing voice recognition during a VR presentation to identify additional human speech by the same person that provided the voice sample. Thus, the trigger may be recognition of that particular person's voice.

However, in the event that the particular sound the end user wants to use as a trigger for presentation of an AR mode/real world view is something other than human speech, such as the particular doorbell in the end user's own home or the end user's own dog barking, the button 726 may be selected to similarly provide an audio sample to use as a template for subsequently executing sound recognition during a VR presentation to identify a matching sound based on pitch, frequency, etc.

Still describing FIG. 7, the GUI 700 may include selectable options for any of the other triggers or criteria discussed herein. For example, an option 728 may be selected to set a trigger as detection of any sound above a threshold decibel level (or other sound level) as defined by the end-user entering numerical input to input box 730 to establish the threshold. As another example, an option 732 may be selected to set a trigger as detection of one or more particular songs played through another device and that may be unrelated to the VR/AR content presentation itself. The songs may be selected using a file browser presented responsive to selection of the song select button 734. Either of these triggers may then result in a real-world window or full AR rendering being presented to the user showing a forward-facing field of view from the headset.

As another example, the GUI 700 may include an option 736 to select a particular upcoming time of day as the trigger. Sub-option 738 may then be selected to set the time according to input-to-input boxes 740 to specify the time, while sub-option 742 may be selected to set evening/sundown hours as the trigger. A particular day's sundown time may be determined by the device from a weather website or publicly accessible government weather service data, for example. Then responsive to one of these triggers a real-world window or full AR rendering may be presented to the user showing a forward-facing field of view from the headset.

Though not shown in FIG. 7 for simplicity, still other trigger options may be included on the GUI 700. For example, an option may be presented to set a trigger as a change in ambient lighting/luminosity (or a change in lighting by more than a threshold amount) identified by the device's camera, as might occur based on someone else turning on a lamp or light bulb within the environment. An option may also be presented to set a trigger as a particular weather or geological event occurring, such as a tornado, hurricane, other storm, or earthquake occurring (where responsive to selecting this option, the user may be presented with another GUI through which the user may select one or more of those particular events to use as the trigger). Again, these triggers, a real-world window or full AR rendering may be presented to the user showing a forward-facing field of view from the device.

Another option may even be presented to set a trigger as an incoming communication or other notification being received at another paired device such as the end user's smartphone or laptop computer. The incoming communication may be a telephone call, video call, email, social media message, text message, etc. Other notifications may include various other app notifications like calendar reminders, alarms, etc. In response to one of those notifications being communicated to the device of FIG. 7, the device may present real-world window or full AR rendering either showing the other device itself or showing a forward-facing field of view.

Still in reference to FIG. 7, the GUI 700 may also include options 744, 746 to, where applicable, track the bearing from the device to a real-world location of a triggering object with a floating window on the device's display (option 744), or to instead present a picture-in-picture window or other window located at a fixed location on the display (option 746). Though not shown, an option to select a full screen AR mode may also be presented. And again, note that these three options may be configured for more than one trigger or may be selected on a per-trigger basis so that different triggers might result in different AR content/real world view presentations.

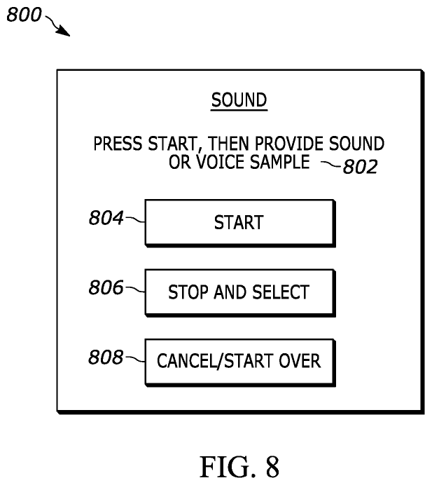

Now describing FIG. 8, it shows an example GUI 800 that may be presented on the display of a device configured to undertake present principles. The GUI 800 may be presented, for example, responsive to selection of one of the buttons 724 or 726 described above to provide a voice sample or other sound sample to use for identification of a particular voice/sound as an AR-triggering criterion consistent with present principles.

As shown in FIG. 8, the GUI 800 may include a prompt 802 instructing an end user to select the start button/selector 804 and then provide a sound or voice sample that will be detected by the device's microphone. Then after actually providing the sample, the user may select the button 806 to, with a single selection of the button 806, stop the voice recording and upload the recording to the device/system to use the sound indicated in the sample as a criterion. However, should the user instead wish to cancel or provide a better sample, button 808 may be selected to start the process over.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A device, comprising:
at least one processor;
a display accessible to the at least one processor; and
storage accessible to the at least one processor and comprising instructions executable by the at least one processor to:
present first virtual reality (VR) content on the display;
determine that an end user-defined trigger has occurred for transitioning from presenting VR content to presenting augmented reality (AR) content; and
responsive to the determination, transition presentation of at least part of the first VR content to presentation of first AR content;
wherein the end user-defined trigger comprises recognition of any sound above a threshold sound level.

2-3. (canceled)

4. The device of claim 1, wherein the first AR content indicates virtual objects from the first VR content that would otherwise be shown in VR absent the end user-defined trigger occurring.

5-12. (canceled)

13. A method, comprising:
presenting first virtual reality (VR) content on a display;
determining that an end user-defined criterion exists for transitioning VR content from opaque to at least partially transparent; and
responsive to the determining, transitioning at least part of the first VR content from opaque to at least partially transparent;
wherein the end user-defined criterion comprises a change in ambient lighting.

14-17. (canceled)

18. At least one computer readable storage medium (CRSM) that is not a transitory signal, the computer readable storage medium comprising instructions executable by at least one processor to:
present first virtual content on a display;
determine that an end user-defined criterion exists for transitioning from opaque presentation of virtual content to presentation of a real-world environment; and
responsive to the determination, present, via the display, a window that moves about the display to show a particular object within the real-world environment in place of at least some of the first virtual content, the window moving about the display over time to continue indicating the object through the window in an actual viewing direction to the object as the position of the object changes with respect to the display.

19-20. (canceled)

21. The CRSM of claim 18, wherein the actual viewing direction to the object is relative to a forward-facing axis of the display.

22. The CRSM of claim 18, wherein the instructions are executable to:
use computer vision to track the location of the object for presenting the window to indicate the object via the display as the position of the object changes with respect to the display.

23. The CRSM of claim 18, wherein the end user-defined criterion comprises recognition of sound above a threshold sound level, the object identified by the at least one processor as producing the sound.

24. The CRSM of claim 18, wherein the end user-defined criterion comprises a change in ambient lighting, the ambient lighting being lighting other than that produced by the display.

25. The CRSM of claim 18, wherein the end user-defined criterion comprises one or more of: the closing of a door, the opening of a door.

26. The CRSM of claim 18, wherein the end user-defined criterion comprises another person besides an end user being recognized through voice recognition as speaking, the other person establishing the object.

27. The device of claim 1, wherein the end user-defined trigger comprises a change in ambient lighting, the ambient lighting being lighting other than that produced by the display.

28. The device of claim 1, wherein the instructions are executable to:
responsive to the determination, present, via the display, a window that moves about the display to show a particular object within the real-world in place of at least some of the first VR content, the window moving about the display over time to continue indicating the object through the window in an actual viewing direction to the object as the position of the object changes with respect to the display.

29. The device of claim 28, wherein the actual viewing direction to the object is relative to a forward-facing axis of the display.

30. The device of claim 1, wherein the instructions are executable to:
transition presentation of at least part of the first VR content to presentation of the first AR content to show a real-world object in a picture-in-picture window.

31. The device of claim 1, comprising a microphone, wherein the sound above the threshold sound level is detected using the microphone.

32. The device of claim 1, wherein the instructions are executable to:
present a graphical user interface (GUI), the GUI comprising a setting at which the threshold sound level is definable.

33. The method of claim 13, wherein the ambient lighting is lighting other than that produced by the display.

34. The method of claim 13, wherein the end user-defined criterion comprises recognition of sound above a threshold sound level.

35. The method of claim 13, comprising:
responsive to the determining, presenting, via the display, a window that moves about the display to show a particular object within the real-world in place of at least some of the first VR content, the window moving about the display over time to continue indicating the object through the window in an actual viewing direction to the object as the position of the object changes with respect to the display.

36. The method of claim 35, wherein the actual viewing direction to the object is relative to a forward-facing axis of the display.
